(19) United States
(12) Patent Application Publication
(10) Pub. No.: US 2008/0184752 A1
(43) Pub. Date: Aug. 7, 2008

(54) Security key board cover

(76) Inventor: David Lee Warren, Baltimore, MD (US)

Correspondence Address: DAVID WARREN, 116 VIOLET HILL WHITE WAY, BALTIMORE, MD, 21201, US

(21) Appl. No.: 11/506,994

(22) Filed: Feb. 1, 2007

(51) Int. Cl. E05B 9/08

(52) U.S. Cl. 70/450; 70/451

(57) ABSTRACT

The security keyboard cover can be make with 0.065 gage aluminum material And ⅛ thick steel material.

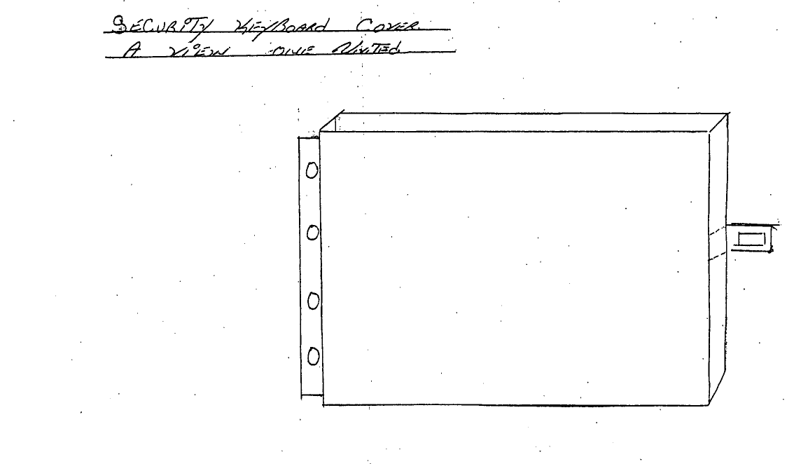

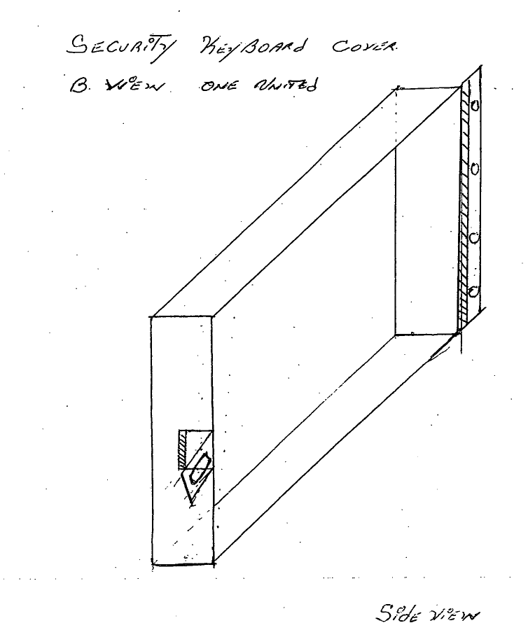

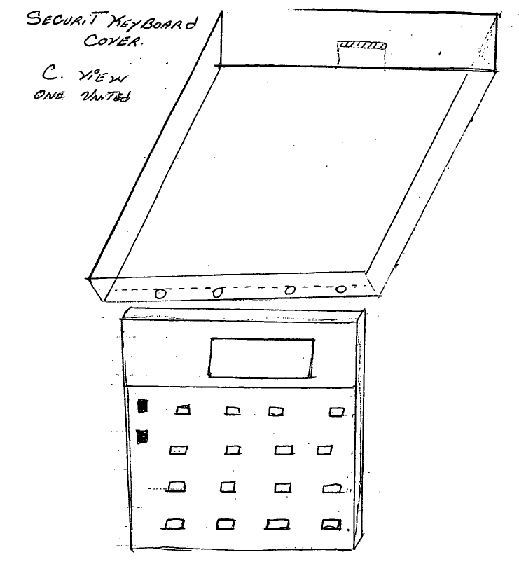

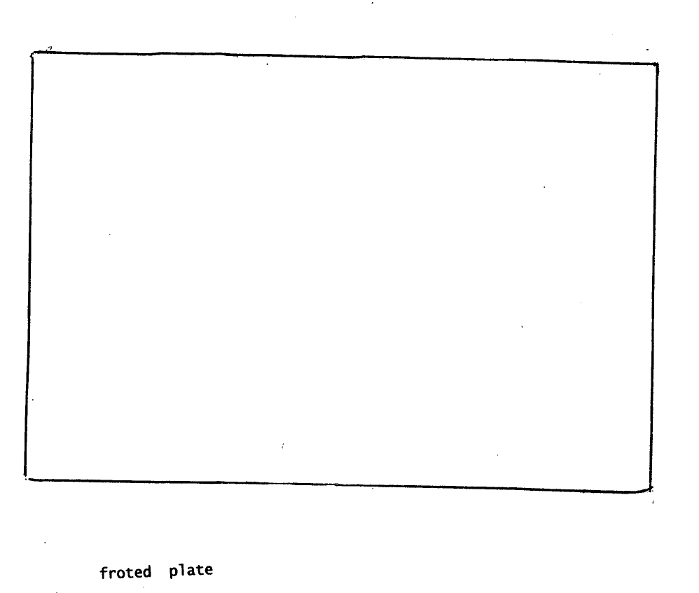

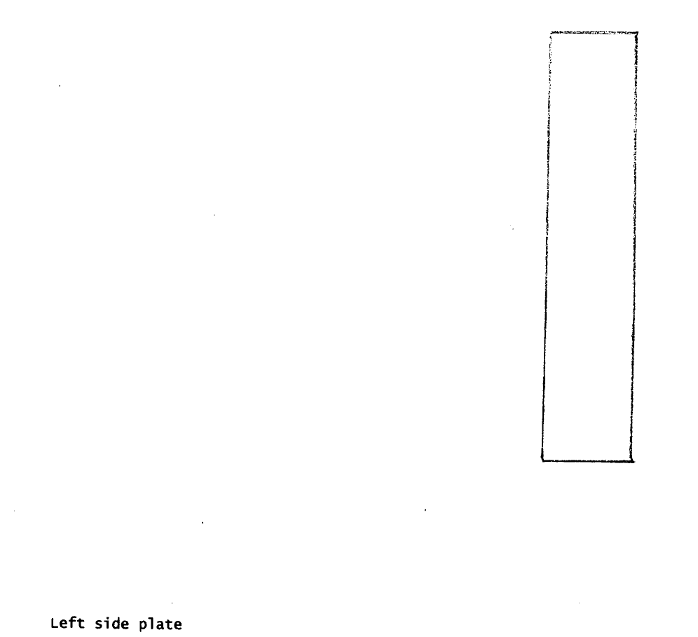

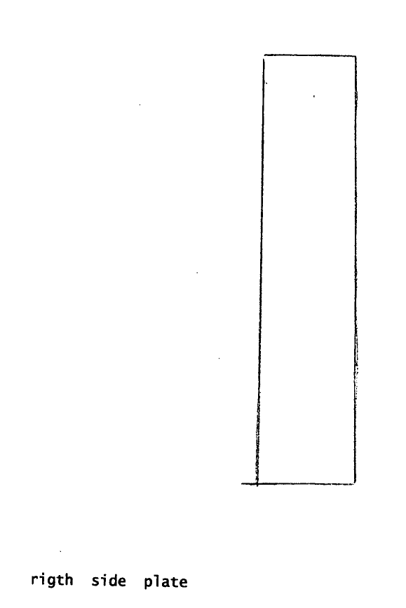

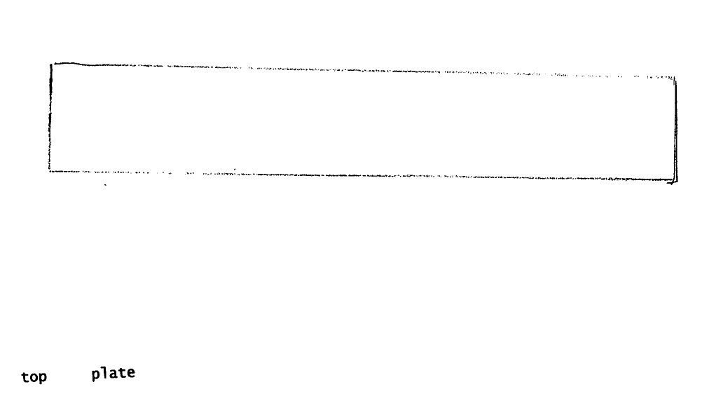

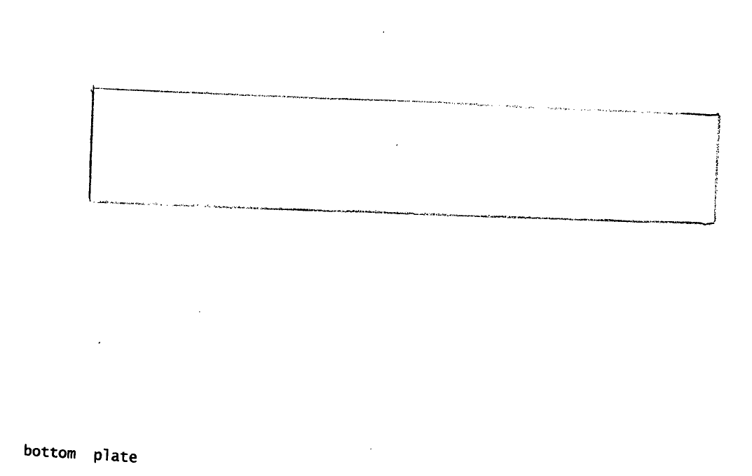

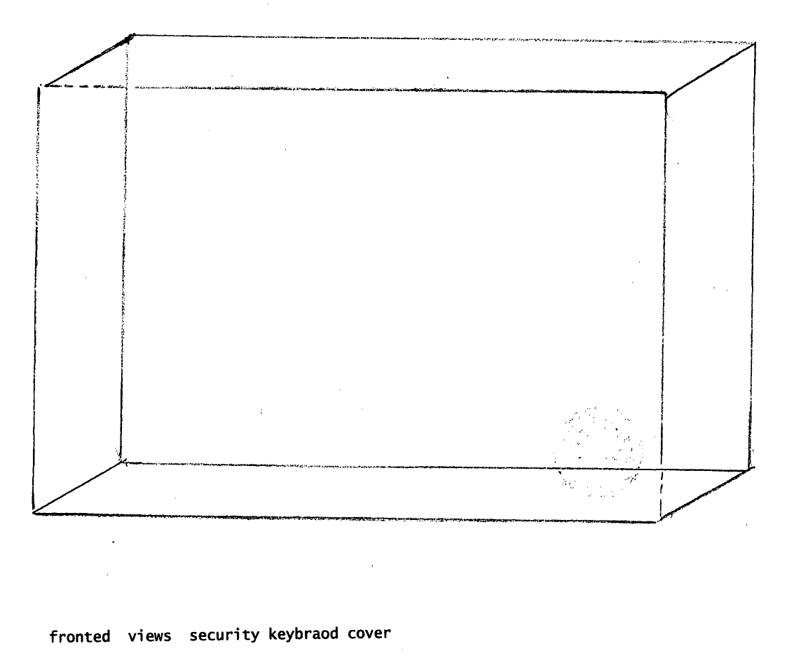

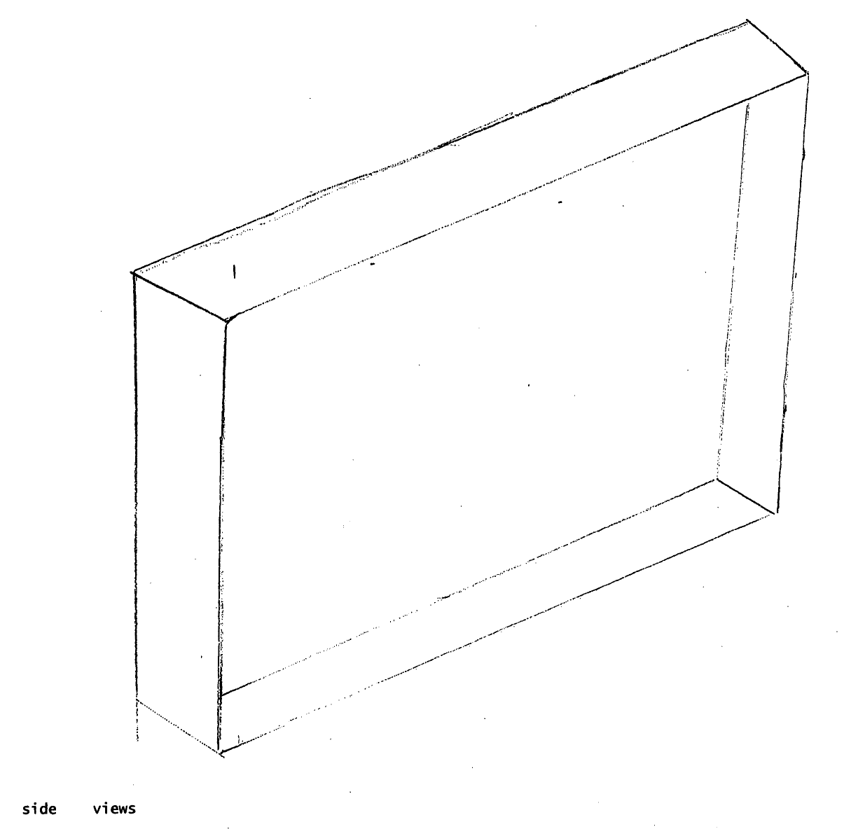

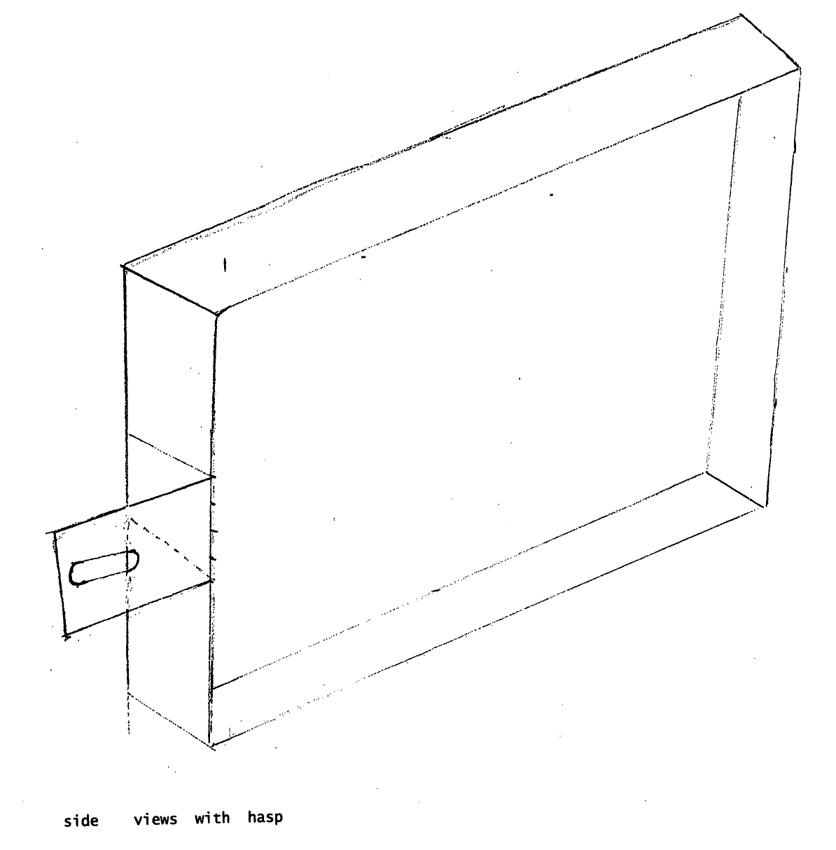

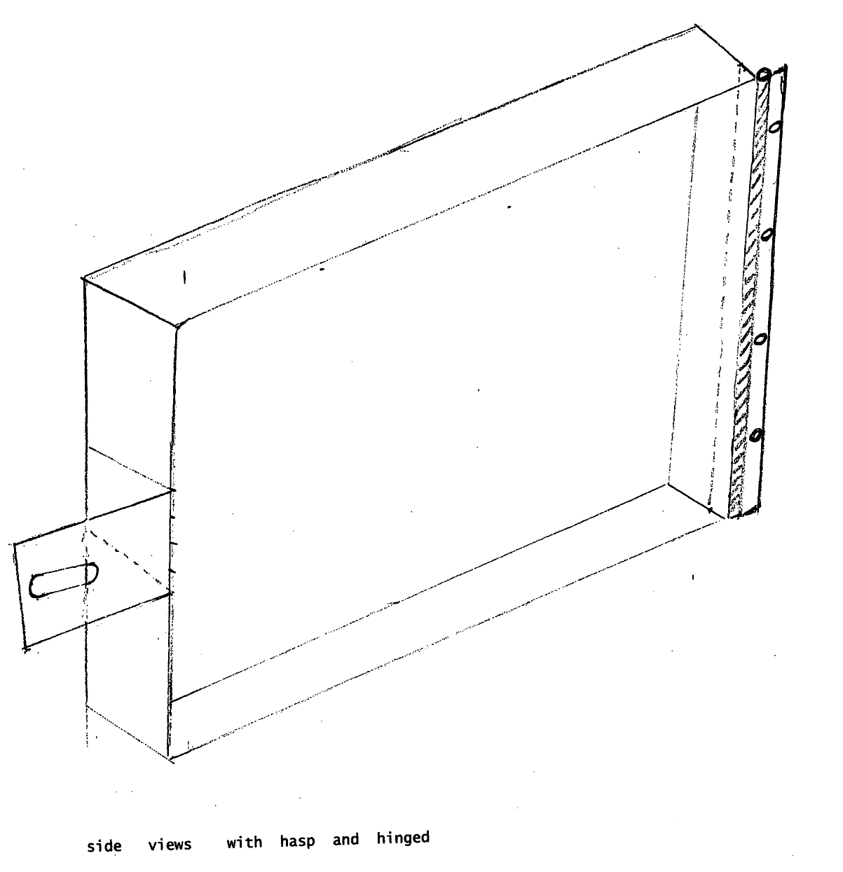

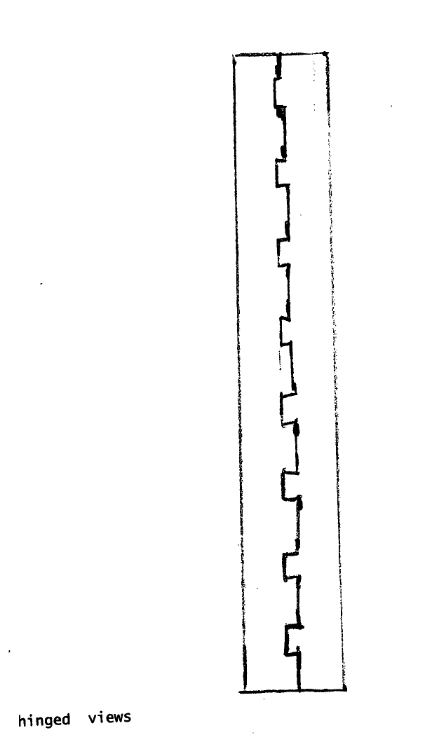

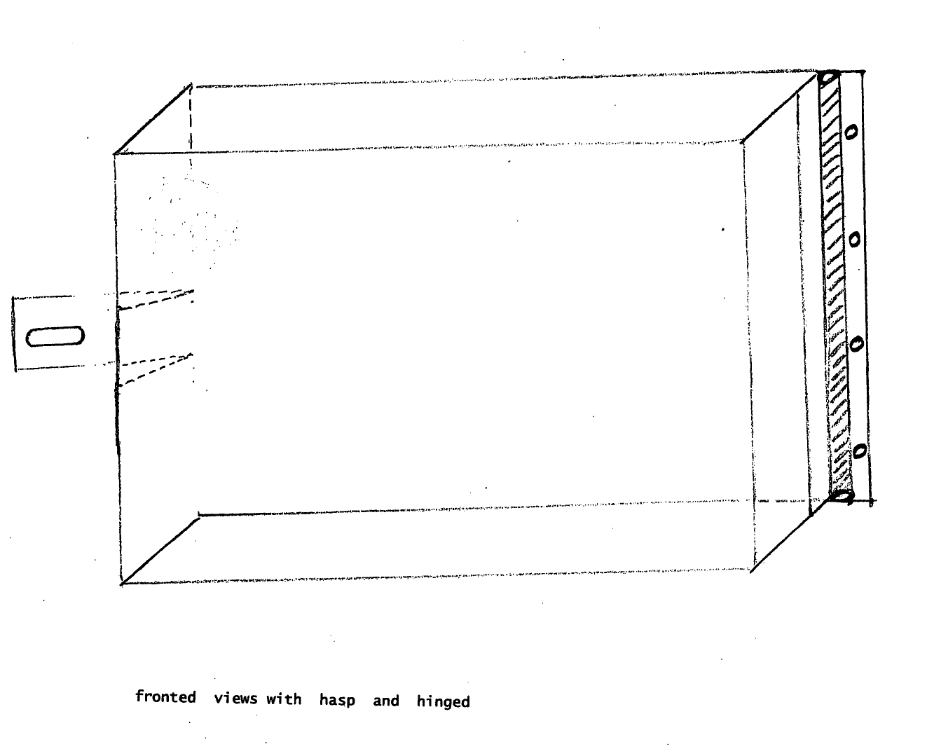

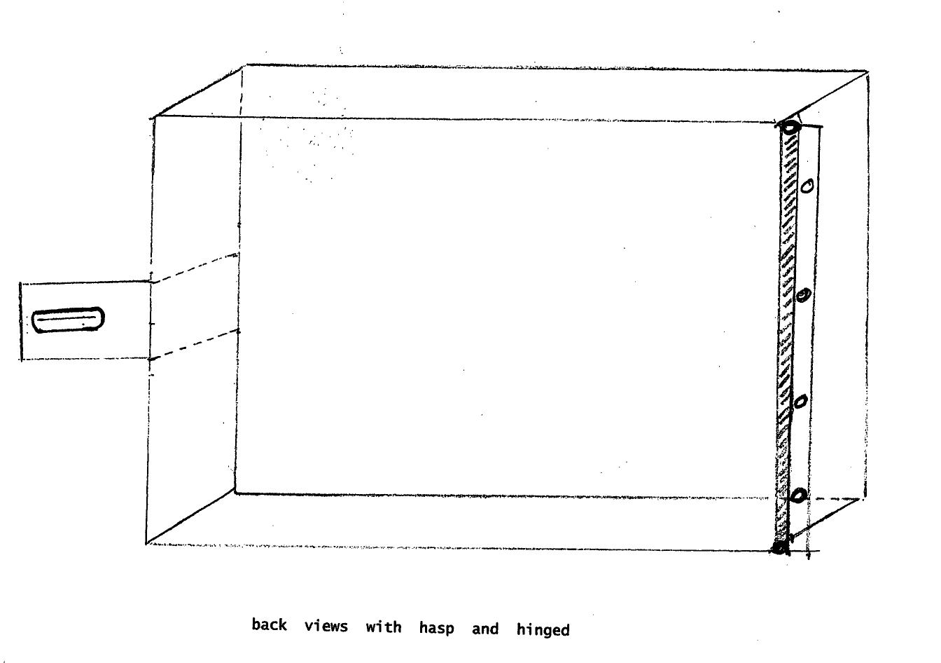

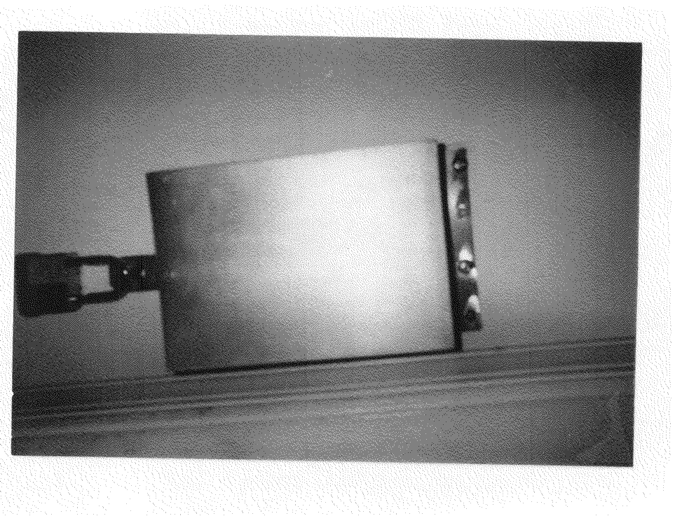

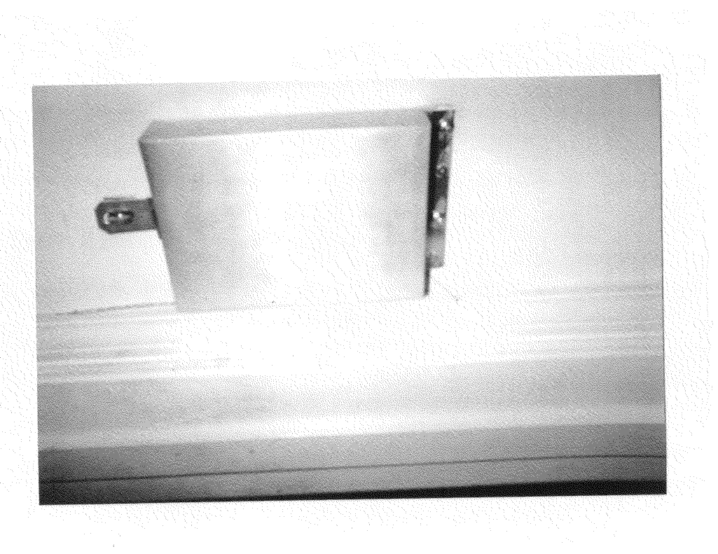

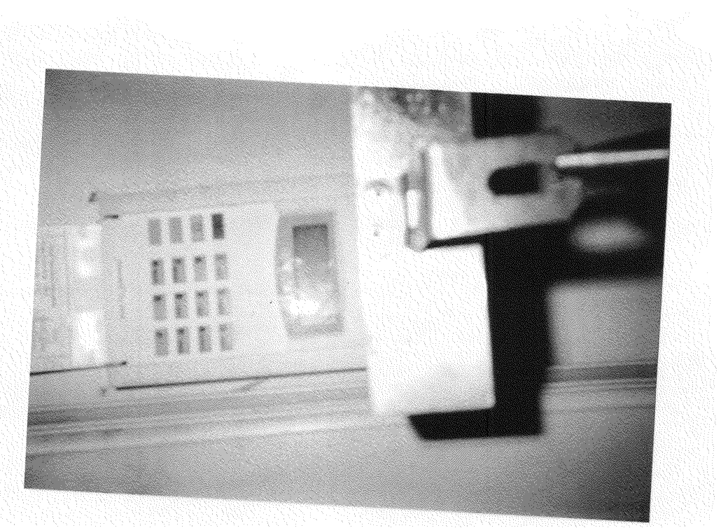

The security keyboard cover is consist of five parts, that assemble or bend Together or come together for a particular purpose.
The poin of this security keyboard cover is that it can be install in horizontal or vertical position or direction.

After the security keyboard cover is make into one united.

Assemble one 2½ safety hasp in the center of the security keyboard cover Or united.
Assemble one 5⅛=⅝=⅝ hind on to top open end Of security keyboard cover.

After the security keyboard cover is make into one united.

Assemble one 2½ safety hasp in the center of the security keyboard cover Or united.
Assemble one 5⅛=⅝=⅝ hind on to top open end Of security keyboard cover.

It's intention is to

Deter

Prevent

To turn aside or away

To frighten

To discourage

Security keyboard cover is to cover or shiel from destruction

To stop or hinder some one intering your home

To turn aside or away form breaking into your home or dwelling

To discourange another with intent to commit a felony

To enable or to stop some one frome cutting off your sytem

### Security Keyboard Cover

security keyboard cover is consist of five parts

the first one part is the back

the back is a ⅛ thick plate the plate size is 5⅛ wide by 7¼ long

the second two parts are the side

the two side is a ⅛ thick plate sizes and are 1½ wide by 7¼ lond; wiht a ¼ hole on the side of one plate for the wire to go under the third part is the botton. the botton is a ⅛ thick plate.

the size is 1½ wide by 5⅛ long the four part is the top. the top plate is a ⅛ thick plate.

the size is 1½ wide by 5⅛ long.

Assemble one 2½ safety hasp in center of security keyboard cover. Safety hasp to be bend on 90 degree angle.

Assemble one 5⅛ long by ⅝ [symbol] ⅝ hind on to top, open of security keyboard cover.

Security keyboard cover can be make with any material.

Steel

Plastic

Aluminum and brass material.

It can be make to fit all size security keyboard.

The security keyboard cover come in one united.

It is made into one part.

It is made to cover your security keyboard.

The security keyboard cover come in one united.

It is made into one part.

It is made to cover your security keyboard

### Installment Direction

To install your security keyboard cover to wood.

You would need four wood screw #8 or #6 by 1½ long flat head Phillips wood screw.

### Concrete or Cement

You would need metal or plastic anchor ¼; and bolts ¼ # 1½ long.

### Sheet Rock

You would need ¼ plastic anchor and #8 or #10 flat head Phillips wood screw or sheet metal screw 1 or 1¼ long.

Best bolts to use is 3/16=2 or 3/16=2½ toggle bolts for sheet rock.

### People to Install Cover

Carpenter; sheet rock worker; technician who has detail of a subject or occupation or do it your self.

### Importance

Once install as your security services to increase your cut off time or your entry time by 30 second.

I claim:

1. This Security Keyboard Cover protects your household to deter and stops others from entering into your home
This Security Keyboard Cover stops the intent to commit a felony
